(19) United States
(12) Patent Application Publication
(10) Pub. No.: US 2007/0180271 A1
(43) Pub. Date: Aug. 2, 2007

(54) Apparatus and method for providing key security in a secure processor

(75) Inventors: Akiyuki Hatakeyama, Tokyo (JP); H. Peter Hofstee, Austin, TX (US); Kanna Shimizu, Austin, TX (US)

Correspondence Address: IBM CORP. (WIP);c/o WALDER INTELLECTUAL PROPERTY LAW, P.C., P.O. BOX 832745, RICHARDSON, TX, 75083, US

(73) Assignee: IBM Corporation

(21) Appl. No.: 11/345,848

(22) Filed: Feb. 2, 2006

(51) Int. Cl. G06F 12/14; H04L 9/00; H04L 9/32; G06F 11/30; G06F 11/00; G06F 1/26; G08B 13/00; G08B 21/00; G08B 29/00

(52) U.S. Cl. 713/193; 380/277; 713/194; 726/34

(57) ABSTRACT

An apparatus and method for providing key security in a secure processor are provided. With the apparatus and method, a two-tiered key security mechanism is provided. On a first tier, a decryption mechanism and a fixed size storage area for a core key are hard-wired into the chip design. It is this first tier that is common to all systems and customers utilizing the processor design. On a second tier, off-chip but within the system is a secondary security key storage device that stores all the keys that are required by the particular system architecture. The off-chip storage device is programmed with the necessary keys before the system is shipped to the customer and thus, provides the needed flexibility. For protection, the keys are stored as an encrypted image using the core key stored on-chip.

### BACKGROUND

1. Technical Field:

The present application relates generally to an improved data processing device. More specifically, the present application is directed to an apparatus and method for providing key security in a secure processor.

2. Description of Related Art:

For a system with security functions, management of its various security keys is a critical function. Especially important are the core keys that are shipped with the system. These keys are at the root of secrecy and trust. Once these keys are exposed, all guarantees of secrecy, authenticity, and integrity of the system are compromised. Therefore, hardware implementation storage methods are greatly preferred over software-based storage method because of the inherent robustness of hardware. Specifically, on-chip key storage would be highly desirable because it will not expose the keys to chip-to-chip or memory-to-chip sniffing.

Unfortunately, some on-chip storage has a major disadvantage in that it is very inflexible. Once a chip design is fixed, the number of bits to securely store a key is fixed. However, to service different customers, the same chip may need to be able to support various security architectures that differ in their hardware requirements. For example, different encryption algorithms may require keys of different lengths. As a further example, different end systems may need to be shipped with a different number of keys. For example, Trusted Platform Module (TPM) chips, as specified by the Trusted Computing Group (TCG), require at least two keys (endorsement key and storage root key) to be shipped with the system. Other systems require just one key or more than two keys. Since chip area is a precious resource, the key storage will be optimized towards the minimum size possible. A large area cannot be optimally reserved for storing a flexible amount of key data.

### SUMMARY

In view of the above, it would be beneficial to have a flexible processor design that may be shipped with an arbitrary number of keys of arbitrary size depending upon the end system and customer requirements. It would further be beneficial to have such a flexible processor design in which the keys are robustly stored and protected by a hardware mechanism such that the protection provided is equivalent to storing all the key bits on-chip. The illustrative embodiment provides such a flexible and robust processor design.

With the illustrative embodiment, a two-tiered key security mechanism is provided. On a first tier, a decryption mechanism and a fixed size storage area for a decryption key are hard-wired into the chip design. It is this first tier that is common to all systems and customers utilizing the processor design.

On a second tier, off-chip, but within the system, is a read-only memory (ROM) that stores all the keys that are required by the particular system architecture. The off-chip ROM is programmed with the necessary keys before the system is shipped to the customer and thus, provides the needed flexibility. For protection, the keys are stored as an encrypted image in the ROM. The on-chip decryption key and decryption mechanism is used to decrypt this key image.

The keys in the off-chip ROM can be private keys, such as of a public key encryption scheme, or encryption keys, such as with a symmetric key scheme, both of which are unique to the chip and must be kept secret. For these keys, it is especially critical that they are encrypted on the ROM. Alternatively, a public key that does not require secrecy but requires tamper protection can be stored as well. The type and number of keys are determined by the system security architecture for the particular system implementation using the processor of the illustrative embodiment.

In addition to the above, the processor according to the illustrative embodiment includes an isolation mode where an on-chip execution and storage location of the chip becomes isolated and protected via hardware mechanisms. In response to this isolation mode being invoked, the hardware decryption mechanism is activated, and the encrypted key image is fetched and decrypted (using the on-chip decryption key and decryption mechanism) inside the protected execution and storage area. Thus, without the invocation of any software, the keys are now accessible within a hardware protected area.

Since the keys are stored encrypted off-chip and their decryption is done through a pure hardware mechanism on-chip, the security of these keys is equivalent to those stored on-chip.

In one exemplary embodiment illustrative of the present invention, a method is provided in which at least one on-chip core key is provided and stored on a system-on-a-chip. At least one on-chip decryption mechanism is also provided on the system-on-a-chip and at least one secondary security key is provided in the off-chip storage device. The at least one secondary security key may be encrypted using the core key and an encryption algorithm corresponding to the at least one decryption mechanism. The at least one on-chip decryption mechanism may decrypt the at least one secondary security key using the core key. The decrypted at least one secondary security key may be used to perform a secure operation in the system-on-a-chip.

The on-chip core key may be provided in hardware that is hardwired into the system-on-a-chip by a manufacturer prior to shipping of the data processing system to a customer. At least one of the on-chip core key or the decryption mechanism may be embedded in a control processor of the system-on-a-chip. At least one of the on-chip core key or the decryption mechanism may be provided as an independent unit coupled to a bus of the system-on-a-chip. Moreover, at least one of the on-chip core key or the decryption mechanism may be provided in association with a processor of the system-on-a-chip and may be solely controlled by the associated processor.

In addition to the above, the method may further comprise generating an isolated protected execution environment that includes a processor, the on-chip core key, a portion of a local storage device that is local to the processor, and the on-chip decryption mechanism. The isolated protected execution environment may not be accessible by other processors in the data processing system that are external to the isolated protected execution environment. Moreover, the secure operation may be performed within the isolated protected execution environment. The at least one secondary security key may be decrypted by the at least one on-chip decryption mechanism within the isolated protected execution environment. The decrypted at least one secondary security key may be stored in the portion of the local storage device that is part of the isolated protected execution environment.

The method may further comprise determining if the secure operation is complete and deleting the decrypted secondary security keys from the portion of the local storage device that is part of the isolated protected execution environment if the secure operation is complete. The method may also comprise loading, into the portion of the local storage device that is part of the isolated protected execution environment, one of encrypted data or encrypted instructions for processing by the processor that is part of the isolated protected execution environment. Further, the method may also comprise decrypting the loaded encrypted data or encrypted instructions using the decrypted at least one secondary security key and processing the decrypted data or decrypted instructions using the processor that is part of the isolated protected execution environment, to thereby perform the secure operation.

In an exemplary embodiment illustrative of the present invention, the data processing device may be part of a toy, a game machine, a game console, a hand-held computing device, a personal digital assistant, a communication device, a wireless telephone, a laptop computing device, a desktop computing device, or a server computing device. Furthermore, the system-on-a-chip may have a heterogeneous architecture comprising a core processing unit operating based on a first instruction set and at least one co-processing unit operating based on a second instruction set different from the first instruction set.

In an exemplary embodiment illustrative of the present invention, a data processing system is provided that comprises a processor provided on a system-on-a-chip, an on-chip core key storage device coupled to the processor and which stores an on-chip core key, an on-chip decryption mechanism coupled to the processor, and an off-chip security key storage device coupled to the chip which stores at least one secondary security key.

These and other features and advantages of the present invention will be described in, or will become apparent to those of ordinary skill in the art in view of, the following detailed description of the exemplary embodiments illustrative of the present invention.

### BRIEF DESCRIPTION OF THE DRAWINGS

The novel features believed characteristic of an illustrative embodiment of the present invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is an exemplary block diagram of a microprocessor chip in which aspects of an illustrative embodiment of the present invention may be implemented;

FIG. 2 is an exemplary diagram illustrating an interaction of the primary operational components of an illustrative embodiment of the present invention when decrypting off-chip security keys using an on-chip core key and decryption mechanism;

FIG. 3 is an exemplary diagram illustrating transitions between isolated and non-isolated states as initiated by a processing unit in accordance with one exemplary embodiment illustrative of the present invention; and

FIG. 4 is a flowchart outlining an exemplary operation of one exemplary embodiment illustrative of the present invention for decrypting off-chip security keys using an on-chip core key and decryption mechanism.

### DETAILED DESCRIPTION OF THE PREFERRED EMBODIMENTS

The following illustrative embodiment provides a flexible and robust mechanism for shipping an arbitrary number and size of security keys with a same processor design. The illustrative embodiment may be implemented in any processor design in which an on-chip key storage may be provided and an off-chip key storage may be provided. In one exemplary embodiment, the processor design or architecture, in which the exemplary aspects of the illustrative embodiment are implemented, is a Cell Broadband Engine (CBE) architecture available from International Business Machines, Inc. The CBE architecture is only exemplary of the possible processor architectures in which the illustrative embodiment may be implemented and the description of such in the following detailed description is not intended to state or imply any limitation with regard to the types of processor architectures in which the illustrative embodiment may be implemented.

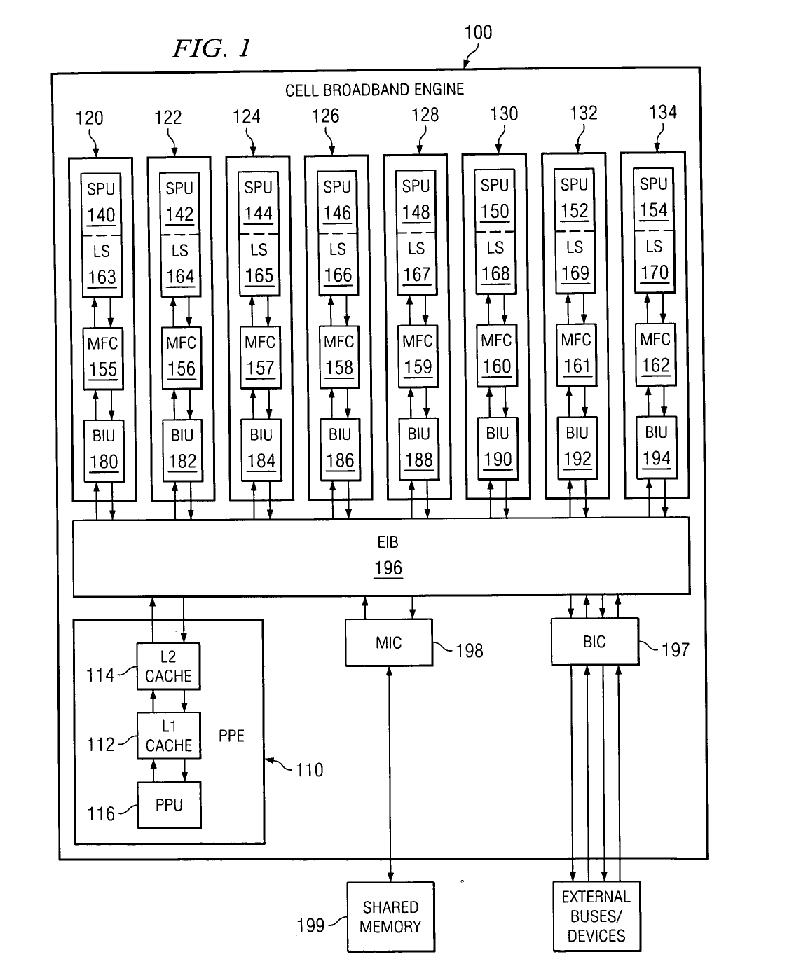

FIG. 1 is an exemplary block diagram of a microprocessor chip in which aspects of the illustrative embodiment may be implemented. The depicted microprocessor chip is one example of a CBE architecture in which exemplary aspects of the illustrative embodiment may be implemented. As shown in FIG. 1, the CBE 100 includes a power processor element (PPE) 110 having a processor (PPU) 116 and its L1 and L2 caches 112 and 114, and multiple synergistic processor elements (SPEs) 120-134 that each has its own synergistic processor unit (SPU) 140-154, memory flow control 155-162, local memory or store (LS) 163-170, and bus interface unit (BIU unit) 180-194 which may be, for example, a combination direct memory access (DMA), memory management unit (MMU), and bus interface unit. A high bandwidth internal element interconnect bus (EIB) 196, a bus interface controller (BIC) 197, and a memory interface controller (MIC) 198 are also provided.

The CBE 100 may be a system-on-a-chip such that each of the elements depicted in FIG. 1 may be provided on a single microprocessor chip. Moreover, the CBE 100 is a heterogeneous processing environment in which each of the SPUs may receive different instructions from each of the other SPUs in the system. Moreover, the instruction set for the SPUs is different from that of the PPU, e.g., the PPU may execute Reduced Instruction Set Computer (RISC) based instructions while the SPUs execute vectorized instructions.

The SPEs 120-134 are coupled to each other and to the L2 cache 114 via the EIB 196. In addition, the SPEs 120-134 are coupled to MIC 198 and BIC 197 via the EIB 196. The MIC 198 provides a communication interface to shared memory 199. The BIC 197 provides a communication interface between the CBE 100 and other external buses and devices.

The PPE 110 is a dual threaded PPE 110. The combination of this dual threaded PPE 110 and the eight SPEs 120-134 makes the CBE 100 capable of handling 10 simultaneous threads and over 128 outstanding memory requests. The PPE 110 acts as a controller for the other eight SPEs 120-134 which handle most of the computational workload. The PPE 110 may be used to run conventional operating systems while the SPEs 120-134 perform vectorized floating point code execution, for example.

The SPEs 120-134 comprise a synergistic processing unit (SPU) 140-154, memory flow control units 155-162, local memory or store 163-170, and an interface unit 180-194. The local memory or store 163-170, in one exemplary embodiment, comprises a 256 KB instruction and data memory which is visible to the PPE 110 and can be addressed directly by software.

The PPE 110 may load the SPEs 120-134 with small programs or threads, chaining the SPEs together to handle each step in a complex operation. For example, a set-top box incorporating the CBE 100 may load programs for reading a DVD, video and audio decoding, and display, and the data would be passed off from SPE to SPE until it finally ended up on the output display. At 4 GHz, each SPE 120-134 gives a theoretical 32 GFLOPS of performance with the PPE 110 having a similar level of performance.

The memory flow control units (MFCs) 155-162 serve as an interface for an SPU to the rest of the system and other elements. The MFCs 155-162 provide the primary mechanism for data transfer, protection, and synchronization between main storage and the local storages 163-170. There is logically an MFC for each SPU in a processor. Some implementations can share resources of a single MFC between multiple SPUs. In such a case, all the facilities and commands defined for the MFC must appear independent to software for each SPU. The effects of sharing an MFC are limited to implementation-dependent facilities and commands.

With the illustrative embodiment, an on-chip key storage and on-chip decryption mechanism are provided in the hardware of the microprocessor or system-on-a-chip, e.g., the Cell Broadband Engine. This on-chip key storage and on-chip decryption mechanism may be provided anywhere on the microprocessor or system-on-a-chip. In one exemplary embodiment, the decryption mechanism and the core key are embedded in the PPE. In another embodiment, the decryption mechanism and/or the core key are provided as an independent unit coupled to the EIB. In this case, the decryption module has the capability to cryptographically secure its communication with other units over the EIB. In another possible embodiment, the decryption mechanism and the core key are solely controlled by the SPEs.

In addition to these on-chip mechanisms, an off-chip memory device, such as a read-only memory (ROM), is provided for storing other security keys in an encrypted manner. This off-chip memory device is still part of the system and is accessible by the Cell Broadband Engine by way of, for example, the MIC 198, BIC 197, or other input/output controller (not shown). The off-chip memory device stores the other security keys that are to be shipped with the system as an encrypted image. The encrypted image is generated using the on-chip core key (for a symmetric key algorithm), or a related key (for an asymmetric key algorithm), and an encryption algorithm corresponding to the on-chip decryption mechanism. As a result, when these security keys in the off-chip memory device are needed to perform security operations, they may be decrypted using the core key and decryption mechanism on-chip.

The keys in the off-chip memory device may be, for example, private keys (such as of a public key encryption scheme), encryption keys (such as with a symmetric key scheme), or the like, which are unique to the chip and must be kept secret. For these keys, it is especially critical that they are encrypted on the off-chip memory device. These keys are to be used for encrypting secret information in an open area such as main memory off of the MIC 198 or a storage device off of the BIC 197, for example. Alternatively, or in addition, these keys may be used to encrypt communication with a third party device, such as an external bus/device via the BIC 197, a third party computing system via a network adapter, or the like. Because of the key's uniqueness to the system and because they are kept secret, information encrypted by these keys remains secure. Moreover, another possible usage scenario is to authenticate a message by signing with these unique keys. All of these capabilities are enabled by the mechanisms of the illustrative embodiment which provide a high-level of protection for system unique keys.

Alternatively, a public key that does not require secrecy, because it is not unique per system, but requires tamper protection can be stored as well. The type and number of keys utilized by the mechanisms of the illustrative embodiment are determined by the system security architecture for the particular system implementation using the processor of the illustrative embodiment. Thus, the illustrative embodiment is not limited to any particular number of, or type of, security keys stored in the off-chip memory device.

Moreover, the processor according to the illustrative embodiment includes an isolation mode where an on-chip execution and storage location of the chip becomes isolated and protected via hardware mechanisms, as discussed in greater detail hereafter. When the hardware decryption mechanism is activated, the encrypted key image is fetched and decrypted using the on-chip decryption key. The resulting decrypted keys are placed inside a protected storage area. Thus, without the invocation of any software, the keys are now accessible within a hardware protected area.

Since the keys are stored encrypted off-chip and their decryption is done through a pure hardware mechanism on-chip, the security of these keys is equivalent to those stored on-chip. Moreover, by providing a configurable off-chip memory device, the same microprocessor or system-on-a-chip design may be used to implement systems having different security requirements and/or customer requirements without having to redesign the microprocessor or system-on-a-chip.

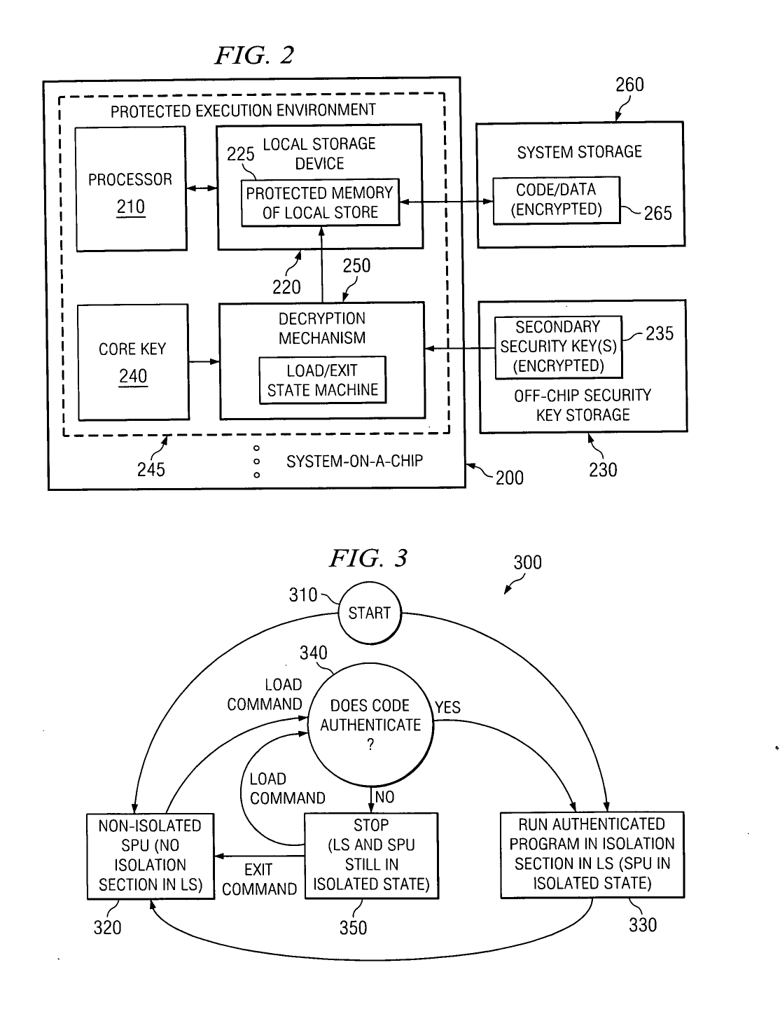

FIG. 2 is an exemplary diagram illustrating an interaction of the primary operational components of the illustrative embodiment when decrypting off-chip security keys using an on-chip core key and decryption mechanism in accordance with one exemplary embodiment illustrative of the present invention. As shown in FIG. 2, a system-on-a-chip 200, in accordance with one exemplary embodiment illustrative of the present invention, includes a processor 210 (such as a SPU in the case of a Cell Broadband Engine), a local storage device 220, an on-chip core key 240, and an on-chip decryption mechanism 250. Also provided in the system, but off-chip, is an off-chip security key storage 230 and a system storage 260.

The processor 210, executing instructions of an application or the like, may require that secure operations be performed on code and/or data loaded into local storage device 220, e.g., code/data 265 obtained from system storage 260. As a result, the processor 210 may issue an instruction to the local storage device 220 to generate a protected portion of memory 225 for use in performing such secure operations. A protected portion of memory 225, in terms of the illustrative embodiment, is an portion of local storage 220 that is only accessible by the processor 210 and may not be accessed by processors or other devices located either on-chip or off-chip. As will be described hereafter, such a protected portion of memory 225 may comprise an isolated section of the local storage device 220, for example.

Once this protected portion of memory 225 is established, secondary security key(s) 235 may be retrieved from the off-chip security key storage 230. In one exemplary embodiment illustrative of the present invention, the secondary security key(s) 235 are used to encrypt the code/data 265. The secondary security key(s) 235 are themselves encrypted using core key 240. The encryption may be performed by an encryption algorithm corresponding to decryption mechanism 250, for example. In a preferred embodiment, the decryption mechanism 250 is hardwired into the chip circuitry. The decryption mechanism 250 may be completely implemented in transistor logic or, alternatively, may leverage the arithmetic capabilities of the processor, in which case, the corresponding sequence of processor instructions may be hardwired into the chip circuitry. Thus, in a preferred embodiment illustrative of the present invention, the decryption mechanism 250 operates on a hardware level rather than a software level.

The secondary security key(s) 235 are encrypted prior to storage in the off-chip security key storage 230 in order to ensure the integrity of these secondary security key(s) 235 against unauthorized access to these secondary security key(s) 235. After the secondary security keys 235 are loaded, the decryption mechanism 250 decrypts them into their usable form using the on-chip core key 240. The decryption mechanism 250 then places the secondary keys within the protected portion of memory 225.

The creation of the protected portion of memory 225, retrieval and decryption of the encrypted secondary security key(s) 235, and loading of the decrypted secondary security key(s) 235 into the protected portion of memory 225 may be performed prior to any required use of the secondary security key(s) 235. Thus, for example, these operations may be performed upon start-up or initialization of the system-on-a-chip 200. Alternatively, these operations may be performed each time secure processing of encrypted code/data 265 is required. Since the protected portion of memory 225 may be accessed only by the processor 210, maintaining the decrypted secondary security key(s) 225 in the local storage device 220 does not raise a security issue. Regardless of the particular implementation chosen, the operations discussed above are all performed in hardware and thus, the security of the system-on-a-chip 200 is maximized.

The code/data 265 that is to be operated upon may be loaded from system storage 260, for example. This code/data may be encrypted using one or more secondary security keys 235 that may be stored in the off-chip security key storage device 230. Thus, when loading the code/data 265 from system storage 260, the secondary security keys 235 may also be loaded into the protected portion of memory 225 as well, if they have not already been loaded into the protected portion of memory 225 at initialization or start-up time, as previously discussed.

The code/data 265 may be loaded into the protected execution environment 245 that includes processor 210, local storage device 220, decryption mechanism 250 and core key 240. This protected execution environment 245 is secure since it is isolated from access by external devices. That is, an external device is not able to access the decryption mechanism 250, the core key 240, or the protected portion of memory 225 in the local storage device 220. Only the processor 210 is able to access the protected execution environment 245 and perform operations with regard to the data/instructions and security keys present within the protected execution environment 245.

Once the code/data 265 is loaded into the protected execution environment 245, e.g., is stored in the protected portion of memory 225, the code/data 265 may be decrypted using the already decrypted secondary security key(s) 235 present in the protected portion of memory 225. The decryption of the code/data 265 may be performed using decryption mechanism 250, for example. Once in a decrypted form, the code/data 265 may be accessed by the processor 210 to perform secure operations.

When the decrypted secondary key(s)235 are no longer required for performing secure operations, these decrypted secondary key(s) 235 may be removed from the protected execution environment 245. For example, the decrypted secondary key(s) 235 may be deleted from the protected portion of memory 225. Alternatively, they may be maintained in the protected execution environment for future use.

As mentioned above, the off-chip security key storage device may be loaded with any number of security keys and any size security keys as is required for the particular implementation of the data processing system. However, the architecture of the system-on-a-chip 200 may remain constant regardless of the particular implementation of the data processing system in which the system-on-a-chip 200 is incorporated. This is because the same number and size of the core key, or core keys, may be used with each particular implementation of the data processing system, to encrypt the secondary security key(s) that are actually used to secure the code/data used by the data processing system. Thus, the mechanism of the illustrative embodiment provides great flexibility in the usage of the system-on-a-chip 200 from a security standpoint. In addition, since all of the security operations for accessing the secondary security key(s) are performed in hardware on the system-on-a-chip 200, the problems with sniffing or other software based mechanisms for circumventing security are avoided by operation of the illustrative embodiment.

As mentioned above, in addition to the on-chip core key storage device, on-chip decryption mechanism, and off-chip security key storage device, the illustrative embodiment further makes use of an isolation mode of operation in the SPUs of the microprocessor or system-on-a-chip in order to generate a protected execution environment, such as protected execution environment 245 in FIG. 2. This isolation mode of operation essentially permits hardware to isolate a portion of a local storage device 220 of a processor so that a protected execution environment 245 is created. The decryption of security keys from the off-chip storage device based on the decryption mechanism and core key stored on-chip may be performed within this protected execution environment so that security operations may be performed. As a result, the integrity of the security keys may be guaranteed.

An example of such an isolation mode of operation is described in co-pending and commonly assigned U.S. Patent Application Publication 2005/0021944, entitled “Security Architecture for System on Chip,” filed on Jun. 23, 2003 and published Jan. 27, 2005, which is hereby incorporated by reference. As described in this co-pending U.S. Patent application, a mechanism for the authentication of code through the partitioning of a local store (LS) into an isolated section and a non-isolated section is provided. The mechanism includes a load/exit state machine (LESM) that contains a core key which is used during a load state machine command. The core key is not otherwise accessible, and can be unique to each system.

Generally, with the system of this co-pending U.S. Patent application, secure processing is performed within the isolated section memory area of the LS. The memory inside the isolated section is addressable only by the associated processor. However, other processors may access memory in the general access area. In other words, the processor can issue load and store commands to memory locations in the local store in either isolated or non-isolated state, but other processors are restricted to issuing commands to the non-isolated region.

Commands to the processor may include the “load” and “exit” commands, as well as a variety of other commands including starting and stopping the processor and a variety of commands for debug purposes. All commands that provide direct access to the register file, external debug and control functions or other state functions of the processor, that are protected in the isolated state, are disabled when the processor is in an isolated state.

The isolated section of the LS may be invoked by a “load” command, and be released by an “exit” command. When the “exit” command is issued, the entire LS becomes general access memory. The load command partitions the LS into a general access section and an isolated section. The load command additionally may transfer code and/or data (load image) from the system memory to the isolated region of the local store, and may initiate authentication and/or decryption of this code and data using the core key. Authentication and/or decryption can be performed by such algorithms and functions as secure hash algorithm (SHA), data encryption standard (DES) or Rivest, Shamir and Adleman algorithm (RSA), but those of skill in the art understand that other authentication and decryption functions and algorithms are within the scope of the present invention.

The illustrative embodiment extends the functionality of the invention described in this co-pending U.S. Patent application by providing a mechanism for storing the core key on-chip while providing secondary security key(s) off-chip. The on-chip core key may be used to encrypt/decrypt the off-chip secondary security key(s) and the off-chip secondary security key(s) may be used to encrypt/decrypt other code/data loaded from system memory. Moreover, in one exemplary embodiment illustrative of the present invention, the encryption/decryption mechanism is provided as hardware on the system-on-a-chip such that all security functions are performed completely within hardware, thereby maximizing the security of the system as a whole.

With the illustrative embodiment, when code/data is loaded into the isolated region of the LS, decrypted and authenticated, the load/exit state machine, which may be provided as part of the decryption mechanism 250, may start execution of the processor at an address within the loaded image in the isolated region of the LS. The isolation section, i.e. the protected portion of memory 225, limits access to sensitive data and code within the isolated section to commands issued from the processor 210. Generally, the partitioning of the LS into a general section and isolated section avoids any other device other than the processor 210 from copying, modifying or otherwise corrupting any code or data stored within the isolated section 312.

The exit function, invoked by the exit command, is the only way in which the isolated region of the LS can be released to be used as contiguous with the general access section. The exit command also erases all information in the isolated section before releasing the isolated state to the general access section. The erasure can occur even if the processing within the system is otherwise in a stopped, paused or aborted condition.

FIG. 3 is an exemplary diagram illustrating transitions between isolated and non-isolated states as initiated by a processing unit in accordance with one exemplary embodiment illustrative of the present invention. As shown in FIG. 3, in the state diagram 300, after a start transition 310 occurs, the state diagram then advances to a non-isolated state 320 or isolated state 330 depending on the initial system configuration. For the purpose of clarity, state diagram 300 is described as first advancing to state 320. However, those of skill in the art understand that the state diagram 300 can step to either state 320 or to state 330.

In state 320, the LS, e.g., local storage device 220, does not have an isolated section, e.g., protected portion of memory 225. Instead, the entire LS is in the general access state. The processor, e.g., processor 210, is referred to as being in a non-isolated state. Generally, this means that the processor has not been ordered to create an isolation section inside the LS.

Thereafter, to initiate either a secure loader or a secure application, as appropriate, the processor, or a control processor, such as the PPU 116, issues the load command. In transition 340, through employment of the core key and any off-chip security keys that are decrypted using the core key, a load image consisting of code and/or data is loaded, authenticated and/or decrypted. The off-chip security keys, once decrypted using the core key and on-chip decryption mechanism, may be used to decrypt and validate other code/data stored within the isolated section. In any event, if the validation procedure is satisfactory, the load function may start execution of the loaded code image or access of the loaded data.

In one embodiment, this code is a secure loader, responsible for loading, authenticating, and decrypting, the secure application and its data using secondary off-chip security keys. However, in another embodiment, the code can be the application that is to be secure. Typical secure applications can be authentication, encryption, or decryption functions, such as employed for example in a secure sockets layer (SSL) protocol, secure key management, electronic payment management, storage of “virtual money”, periodic validation of the operating system image, and so on. In other words, a secure application can be generally defined as an application in which security and integrity of the application is of concern.

In the transition to state 330, after the load command is issued by the processor but before the authentication of the code, any instructions processing on the local processor have been discontinued. Also, during the transition to state 330, the processor local to the LS disregards any external processor requests to write to the isolated section of the LS and requests by external processors to read the isolated section of the LS return a value of zero or another constant. The processor creates the isolated section of the LS with access restricted to only local processor initiated load/store commands or instruction fetches. The processor also disables accesses to all of the local processor debug/test/diagnostic interfaces. The non-isolated/general access region of the LS retains the same access rights as when the local processor has not issued a partition command for the isolated section. In addition, the local processor disables its asynchronous interrupt when at least part of the LS is in an isolated state, e.g., when an isolated section is present.

In the transition to state 330, some local processor externally accessible registers are typically accessed to obtain a direct memory access address. The direct memory access address corresponds to a specified point of the image of the code to be loaded to the isolated section of the local processor. After finding the code and/or data to be authenticated and/or decrypted, the isolated section of the LS is written with the code and/or data to be authenticated and/or decrypted.

However, if the loaded code and/or data does not authenticate, state 350 is reached, and further authentication of code/data is discontinued. If there is a failure of authentication, as in state 350, the local processor notifies the control processor, e.g., PPU 116, of the authentication failure, while the local processor remains in the isolated state. As a result, the LS retains the isolated region. In one embodiment, the notification of the control processor is performed by a stop and signal command. However, even after being notified of the authentication failure, the control processor is unable to access the code stored within the isolation section through commands issued to the local processor.

However, if the load image is authenticated, the local processor issues an exit command after the execution of the code image/accessing of the data within the isolated section finishes in state 330. After the local processor issues the exit command, all local processor registers, and the isolated section of the LS, are erased or overwritten. This can be done to ensure that no code/data that was previously within the isolated section can be accessed at the instigation of any device when the isolated section is released back to being contiguous with the general section. Access to the LS is unrestricted, and access to the local processor debug/test/diagnostic interfaces are re-enabled upon completion of the exit process.

Finally, the transition to the non-isolated state of the local processor is completed when the local processor notifies the control processor. This can be done by means of an instruction that halts the local processor and signals the control processor, for example.

After the stop state 350 is entered, the control processor can issue an exit command to the local processor. The exit command leads to releasing the isolated section, and stepping to the state 320. Alternatively, in the stop state 350, the processor, or the control processor, can issue another load command to thereby load in other or different code/data to be authenticated, decrypted, and accessed in the protected execution environment.

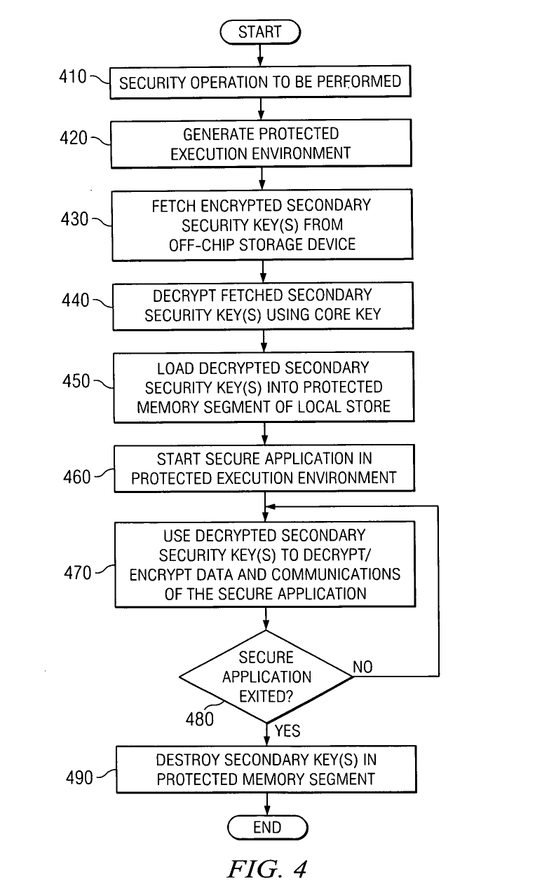

FIG. 4 is a flowchart outlining an exemplary operation of an illustrative embodiment of the present invention for decrypting off-chip security keys using an on-chip core key and decryption algorithm. It will be understood that each block, and combination of blocks, of the flowchart illustration in FIG. 4, can be implemented by computer program instructions. These computer program instructions may be provided to a processor or other programmable data processing apparatus to produce a machine, such that the instructions which execute on the processor or other programmable data processing apparatus create means for implementing the functions specified in the flowchart block or blocks. These computer program instructions may also be stored in a computer-readable memory or storage medium that can direct a processor or other programmable data processing apparatus to function in a particular manner, such that the instructions stored in the computer-readable memory or storage medium produce an article of manufacture including instruction means which implement the functions specified in the flowchart block or blocks.

Accordingly, blocks of the flowchart illustration support combinations of means for performing the specified functions, combinations of steps for performing the specified functions and program instruction means for performing the specified functions. It will also be understood that each block of the flowchart illustration, and combinations of blocks in the flowchart illustration, can be implemented by special purpose hardware-based computer systems which perform the specified functions or steps, or by combinations of special purpose hardware and computer instructions.

As shown in FIG. 4, the operation starts with a security operation having to be performed by a processor unit, e.g., an SPE (step 410). The processor unit generates a protected execution environment (step 420) and fetches the encrypted secondary security key(s) from the off-chip storage device (step 430). The decryption mechanism of the processor unit decrypts the fetched secondary security key(s) using the core key (step 440) and loads the decrypted secondary security key(s) into a protected portion of memory (step 450). The processor unit starts a secure application in the protected execution environment (step 460). The security application uses the decrypted secondary security key(s) to decrypt/encrypt data, instructions, and communications of the secure application (step 470).

The processor unit determines whether the secure application has exited (step 480). If not, the operation returns to step 470 and continues to use the decrypted secondary security key(s) to perform security operations. If the secure application has exited, the decrypted secondary key(s) and any other data stored in the protected portion of memory may be deleted (step 490). The operation then terminates.

Thus, the illustrative embodiment of the present invention provides a two-tiered mechanism for ensuring the security of a system-on-a-chip or microprocessor. In a first tier, a core key or core keys are stored on-chip along with a decryption mechanism. In a second tier, secondary key(s) are encrypted using the core key and stored in an off-chip storage device as encrypted images. The decryption of the secondary key(s) using the core key and decryption mechanism is performed by hardware in a protected execution environment on the chip. As a result, access to the secondary key(s) is made possible without having to invoke software mechanisms. Thus, the security of the system is made flexible by using an off-chip security key storage while maintaining the robustness of the security mechanism at a level as if all of the security keys were stored on-chip.

It should be noted that the above exemplary embodiments illustrative of the present invention are provided as examples only and are not intended to state or imply any limitation with regard to the manner by which the mechanisms of the present invention, as outlined in the following claims, may be implemented. For example, while the above embodiments describe the protected portion of memory as being established in a local storage device associated with a processor, the present invention is not limited to such. Rather, the mechanisms of the present invention may be applied with use of any protected portion of memory that is provided on-chip.

In addition, while the illustrative embodiment has been described in terms of a single core key stored in an on-chip core key storage, the present invention is not limited to such. Rather, any number of core keys and sizes of core keys may be used without departing from the spirit and scope of the present invention. The primary concept is that the same architecture of the system-on-a-chip or microprocessor may be used with multiple implementations of data processing systems meeting customer requires regardless of the number of core keys or size of core keys stored on the chip.

Similarly, while the exemplary embodiments have been described in terms of a single decryption mechanism being provided on-chip, the present invention is not limited to such. Rather, any number of decryption mechanisms may be provided on-chip and may be used in a protected execution environment to perform security operations such as decryption and authentication. For example, the encrypted code/data loaded into a protected execution environment may include a bit or series of bits designating an identifier of the encryption algorithm used to encrypt the code/data. This bit or series of bits may be used within the protected execution environment to select a particular on-chip decryption mechanism and/or on-chip core key to be used in performing security operations on the encrypted code/data.

Moreover, while the exemplary embodiments are described as having each SPU of a Cell Broadband Engine store a copy of the core key(s) and each SPU having its own decryption mechanism, the present invention is not limited to such an embodiment. Rather, the core key(s) and decryption mechanism may be provided in one or more devices that are commonly accessible by all of the processors of the system-on-a-chip or microprocessor.

In addition, while the illustrative embodiment has been described in terms of separate devices for storing the core key(s) and providing the decryption mechanism, the present invention is not limited to such an embodiment. Rather, the core key(s) and decryption mechanism may be provided in the same on-chip security device without departing from the spirit and scope of the present invention. Other modifications to the exemplary embodiments described above, as will become apparent to those of ordinary skill in the art in view of the present description, are intended to be within the scope of the present invention as outlined in the following claims.

The mechanisms of the illustrative embodiment, as described above, are part of the design for an integrated circuit chip. The chip design is created in a graphical computer programming language, and stored in a computer storage medium (such as a disk, tape, physical hard drive, or virtual hard drive such as in a storage access network). If the designer does not fabricate chips or the photolithographic masks used to fabricate chips, the designer transmits the resulting design by physical means (e.g., by providing a copy of the storage medium storing the design) or electronically (e.g., through the Internet) to such entities, directly or indirectly. The stored design is then converted into the appropriate format (e.g., GDSII) for the fabrication of photolithographic masks, which typically include multiple copies of the chip design in question that are to be formed on a wafer. The photolithographic masks are utilized to define areas of the wafer (and/or the layers thereon) to be etched or otherwise processed.

The resulting integrated circuit chips can be distributed by the fabricator in raw wafer form (that is, as a single wafer that has multiple unpackaged chips), as a bare die, or in a packaged form. In the latter case the chip is mounted in a single chip package (such as a plastic carrier, with leads that are affixed to a motherboard or other higher level carrier) or in a multichip package (such as a ceramic carrier that has either or both surface interconnections or buried interconnections). In any case the chip is then integrated with other chips, discrete circuit elements, and/or other signal processing devices as part of either (a) an intermediate product, such as a motherboard, or (b) an end product. The end product can be any product that includes integrated circuit chips, ranging from toys and other low-end applications to advanced computer products having a display, a keyboard or other input device, and a central processor. Moreover, the end products in which the integrated circuit chips may be provided may include game machines, game consoles, hand-held computing devices, personal digital assistants, communication devices, such as wireless telephones and the like, laptop computing devices, desktop computing devices, server computing devices, or any other computing device.

The description of the illustrative embodiment has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method, in a data processing system having a system-on-a-chip and an off-chip storage device, comprising:
providing at least one on-chip core key stored on the system-on-a-chip;
providing at least one on-chip decryption mechanism on the system-on-a-chip; and
providing at least one secondary security key in the off-chip storage device, wherein the at least one secondary security key is encrypted using the core key and an encryption algorithm corresponding to the at least one decryption mechanism, wherein the at least one on-chip decryption mechanism decrypts the at least one secondary security key using the core key, and wherein the decrypted at least one secondary security key is used to perform a secure operation in the system-on-a-chip.

2. The method of claim 1, wherein the on-chip core key is provided in hardware that is hardwired into the system-on-a-chip by a manufacturer prior to shipping of the data processing system to a customer.

3. The method of claim 1, wherein at least one of the on-chip core key or the decryption mechanism are embedded in a control processor of the system-on-a-chip.

4. The method of claim 1, wherein at least one of the on-chip core key or the decryption mechanism are provided as an independent unit coupled to a bus of the system-on-a-chip.

5. The method of claim 1, wherein at least one of the on-chip core key or the decryption mechanism is provided in association with a processor of the system-on-a-chip and is solely controlled by the associated processor.

6. The method of claim 1, further comprising:
generating an isolated protected execution environment that includes a processor, the on-chip core key, a portion of a local storage device that is local to the processor, and the on-chip decryption mechanism, wherein the isolated protected execution environment is not accessible by other processors, in the data processing system, that are external to the isolated protected execution environment, and wherein the secure operation is performed within the isolated protected execution environment.

7. The method of claim 6, wherein the at least one secondary security key is decrypted by the at least one on-chip decryption mechanism within the isolated protected execution environment, and wherein the decrypted at least one secondary security key is stored in the portion of the local storage device that is part of the isolated protected execution environment.

8. The method of claim 7, further comprising:
determining if the secure operation is complete; and
deleting the decrypted secondary security keys from the portion of the local storage device that is part of the isolated protected execution environment if the secure operation is complete.

9. The method of claim 6, further comprising:
loading, into the portion of the local storage device that is part of the isolated protected execution environment, one of encrypted data or encrypted instructions for processing by the processor that is part of the isolated protected execution environment;
decrypting the loaded encrypted data or encrypted instructions using the decrypted at least one secondary security key; and
processing the decrypted data or decrypted instructions using the processor that is part of the isolated protected execution environment, to thereby perform the secure operation.

10. The method of claim 1, wherein the data processing device is part of a toy, a game machine, a game console, a hand-held computing device, a personal digital assistant, a communication device, a wireless telephone, a laptop computing device, a desktop computing device, or a server computing device.

11. The method of claim 1, wherein the system-on-a-chip has a heterogeneous architecture comprising a core processing unit operating based on a first instruction set and at least one co-processing unit operating based on a second instruction set different from the first instruction set.

12. A data processing system, comprising:
a processor provided on a system-on-a-chip;
an on-chip core key storage device coupled to the processor and which stores an on-chip core key;
an on-chip decryption mechanism coupled to the processor; and
an off-chip security key storage device coupled to the chip which stores at least one secondary security key, wherein the at least one secondary security key is encrypted using the core key and an encryption algorithm corresponding to the at least one decryption mechanism, wherein the at least one on-chip decryption mechanism decrypts the at least one secondary security key using the core key, and wherein the decrypted at least one secondary security key is used to perform a secure operation in the system-on-a-chip.

13. The data processing system of claim 12, wherein the on-chip core key is provided in hardware that is hardwired into the system-on-a-chip by a manufacturer prior to shipping of the data processing system to a customer.

14. The data processing system of claim 12, wherein at least one of the on-chip core key or the decryption mechanism are embedded in a control processor of the system-on-a-chip.

15. The data processing system of claim 12, wherein at least one of the on-chip core key or the decryption mechanism are provided as an independent unit coupled to a bus of the system-on-a-chip.

16. The data processing system of claim 12, wherein at least one of the on-chip core key or the decryption mechanism is provided in association with the processor provided on the system-on-a-chip and is solely controlled by the associated processor.

17. The data processing system of claim 12, further comprising:
a local storage device coupled to the processor and which is local to the processor, wherein:
the processor has an isolation mode of operation,
when the processor enters the isolation mode of operation, the processor generates an isolated protected execution environment that includes the processor, the on-chip core key, a portion of the local storage device, and the on-chip decryption mechanism,
the isolated protected execution environment is not accessible by other processors, in the data processing system, that are external to the isolated protected execution environment, and
the secure operation is performed within the isolated protected execution environment.

18. The data processing system of claim 17, wherein the at least one secondary security key is decrypted by the at least one on-chip decryption mechanism within the isolated protected execution environment, and wherein the decrypted at least one secondary security key is stored in the portion of the local storage device that is part of the isolated protected execution environment.

19. The data processing system of claim 18, wherein the processor determines if the secure operation is complete and deletes the decrypted secondary security keys from the portion of the local storage device that is part of the isolated protected execution environment if the secure operation is complete.

20. The data processing system of claim 17, further comprising:
a system storage device, coupled to the processor, that stores at least one of encrypted data or encrypted instructions, wherein:
the processor loads, into the portion of the local storage device that is part of the isolated protected execution environment, one of the encrypted data or encrypted instructions from the system storage device for processing by the processor,
the at least one decryption mechanism decrypts the loaded encrypted data or encrypted instructions using the decrypted at least one secondary security key, and
the processor processes the decrypted data or decrypted instructions to thereby perform the secure operation.

21. The data processing system of claim 12, wherein the data processing system is part of a toy, a game machine, a game console, a hand-held computing device, a personal digital assistant, a communication device, a wireless telephone, a laptop computing device, a desktop computing device, or a server computing device.

22. The data processing system of claim 12, wherein the system-on-a-chip has a heterogeneous architecture comprising a core processing unit operating based on a first instruction set and at least one co-processing unit operating based on a second instruction set different from the first instruction set, and wherein the processor is one of the at least one co-processing units.
